(19) United States
(12) Patent Application Publication
(10) Pub. No.: US 2006/0148314 A1
(43) Pub. Date: Jul. 6, 2006

(54) PCB mounted audio jack

(75) Inventors: Julio C. Castaneda, Coral Springs, FL (US); David I. Blatt, Margate, FL (US); Donald W. Burnette, Sunrise, FL (US); Douglas W. Moskowitz, Weston, FL (US); Francis M. Staszesky, Fort Lauderdale, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: Motorola, Inc., Schaumberg, IL (US)

(21) Appl. No.: 11/026,709

(22) Filed: Dec. 30, 2004

(51) Int. Cl. H01R 9/05

(52) U.S. Cl. 439/581

(57) ABSTRACT

An audio jack (10) is provided for being electrically connected with a PCB (20) and includes a jack body (12) and a plug port (14) configured for receiving an audio plug (16) therein. The jack (10) further includes a plurality of electrical contacts (88, 92, 112) for cooperating with corresponding contacts (42) of the PCB (20). In one form, the jack body (12) includes an integral holding portion (18) configured to engage the PCB (20) for maintaining the body electrical contacts (88, 92, 112) in secure electrical contact with the PCB contacts (42). In another form, gripping members (72-78) are spaced for receiving the PCB (20) therebetween. In this manner, the audio jack (10) can slide onto the PCB (20) for ease of assembly. Preferably, a cut-out opening (90) in the PCB (20) is provided and the jack body (12) is sized to be received therein.

### FIELD OF THE INVENTION

The present invention relates generally to audio jacks, and more particularly to printed circuit board (PCB) mounted audio jacks.

### BACKGROUND OF THE INVENTION

Audio jacks are utilized in many different electronic devices to provide audio signals to a device, or conduct audio signals away from a device by inserting a plug into the jack with the plug being further electrically coupled with an input or output device, such as a microphone, speakers, headphones and other such devices.

There are numerous types of audio jacks depending on the desired implementations. One known audio jack has electrical leads or conductor legs that extend out from under the body thereof for being placed on the surface of the printed circuit board on which corresponding electrical contacts or pads are formed. Accordingly, the entire body of the jack rests on the board surface so that the plug port is also above the board undesirably increasing the profile or height of the audio jack on the board.

Moreover, a separate bracket member is needed to hold the jack on the board to keep the jack contacts in electrical engagement with the board contacts or, alternatively, to hold the jack in proper position during soldering of the contacts together. The separate bracket is undesirable from an assembly standpoint as it requires a separate assembly operation after placing the audio jack in position on the circuit board. Further, portions of the bracket also extend down below the circuit board and along its bottom surface. As is apparent, the mounting bracket significantly and undesirably increases the profile or vertical space requirements in the device housing or casing for the audio jack in addition to that already required for the surface mounted audio jack, as described above.

Accordingly, an easier to assemble audio jack would be desirable. Further, an audio jack that has a lower profile is needed.

### BRIEF DESCRIPTION OF THE DRAWINGS

FIG. 1 is a perspective view of a low-profile audio jack according to the present invention showing a jack body including a plug port and an integrated holding portion for securely mounting the audio jack to a PCB;

FIG. 2 is a perspective view of the audio jack of FIG. 1 turned 180° about its longitudinal axis to show gripping members of the jack body on either side of the port and extending beyond the port at the leading end thereof;

FIG. 3 is a perspective view of a prior audio jack mounted to a circuit board by a separate mounting bracket;

FIG. 4 is a perspective view similar to FIG. 2 broken away to show the prior PCB mounted audio jack in a casing of an electronic device;

FIG. 5 is a bottom plan view of the audio jack showing the plug port in phantom and electrical contacts on either side thereof;

FIG. 6 is a perspective view of the jack in the inverted FIG. 2 orientation with an audio plug received in the jack port;

FIG. 7 is a perspective view of the audio jack and a PCB showing a cutout in the PCB extending between PCB contacts for the audio jack with the audio jack in position for sliding onto the PCB;

FIG. 8 is a perspective view of the audio jack partially slidingly engaged onto the PCB;

FIG. 9 is a schematic view showing several audio jack electrical contacts having cam surfaces for sliding into engagement with the PCB contacts;

FIG. 10 is a schematic view similar to FIG. 8 showing the audio jack contacts engaged on the PCB contacts;

FIG. 11 is a perspective view similar to FIG. 8 but with the audio jack and PCB inverted and the audio jack fully slidingly engaged with the PCB in the PCB cutout;

FIG. 12 is an enlarged perspective view of the audio jack port sectioned to show internal electrical contacts; and

FIG. 13 is a cross-sectional schematic view showing lead connections between the external and internal electrical contacts of the audio jack.

### DETAILED DESCRIPTION OF THE PREFERRED EMBODIMENTS

In accordance with one aspect of the present invention, an audio jack for being electrically connected to a PCB is provided and which includes a body having a plug port and an integral holding portion. The body holding portion is configured to engage the PCB so that electrical contacts of the audio jack stay securely engaged on corresponding contacts on the PCB without requiring a separate jack mounting member for this purpose. Accordingly, the jack having the integral holding portion is assembled to the PCB in a single, assembly operation, rather than first requiring the jack to be placed on the PCB, and then further requiring that a separate bracket member be placed over the jack and PCB to hold the two together as with the previously-described prior jack assembly. In either case, a separate contact connecting step, e.g. soldering, may be undertaken as well.

In another aspect, the jack body has a central bore in which a plug is received and upper and lower gripping member connected to the body on either side of the bore. The spacing between the upper and lower gripping members is substantially matched to the thickness of the PCB so that the gripping members slidingly engage on opposite surfaces of the PCB to preferably provide a friction fit between the audio jack and the PCB. It is also preferred that the PCB be provided with a cut-out opening with the jack body sized to fit therein. In this manner, via the above sliding engagement the plug body can slide into the cut-out opening thus minimizing the profile thereof as compared to the prior audio jack assembly that had the entire jack body placed on the PCB surface along with a portion of the bracket member that extends over the top of the jack body for holding it down on the PCB surface.

It should be noted that the jack is described herein as an audio jack that is incorporated in an electronic device, e.g. cellular phone, to receive an audio plug for transmitting audio signals therebetween. For example, this allows an input device such as a microphone having the plug coupled thereto to transmit audio signals through an output component of the electronic device such as a speaker, transducer or other similar audio output. Nevertheless, it will be appreciated that the present jack can be used in different implementations such as to transmit power to or from the electronic device, e.g. a power jack in a wireless communication device for supplying power thereto. Accordingly, herein the term audio jack should be understood to encompass other implementation of a jack as well.

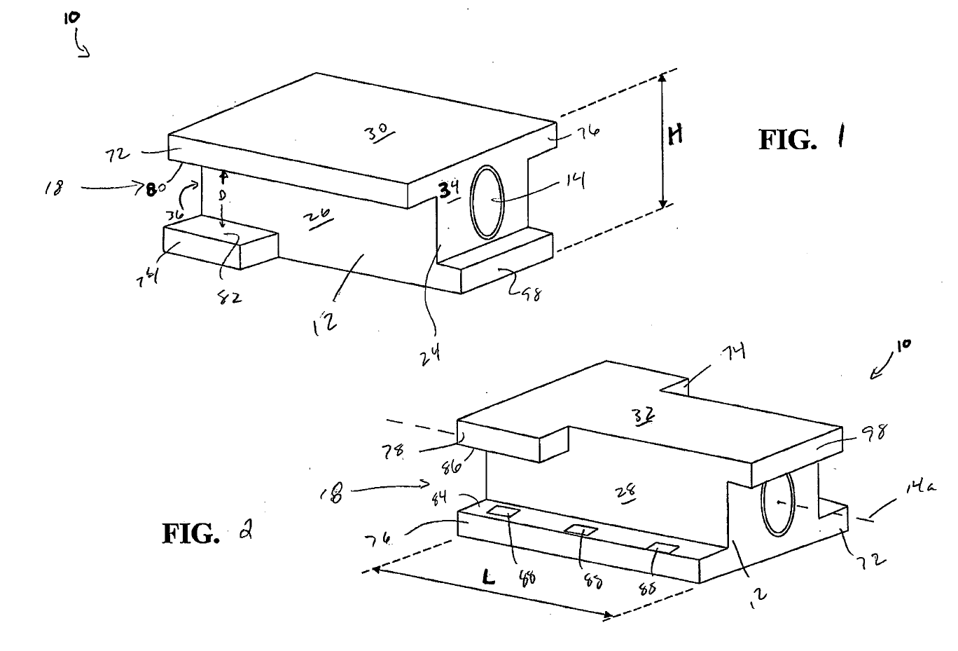

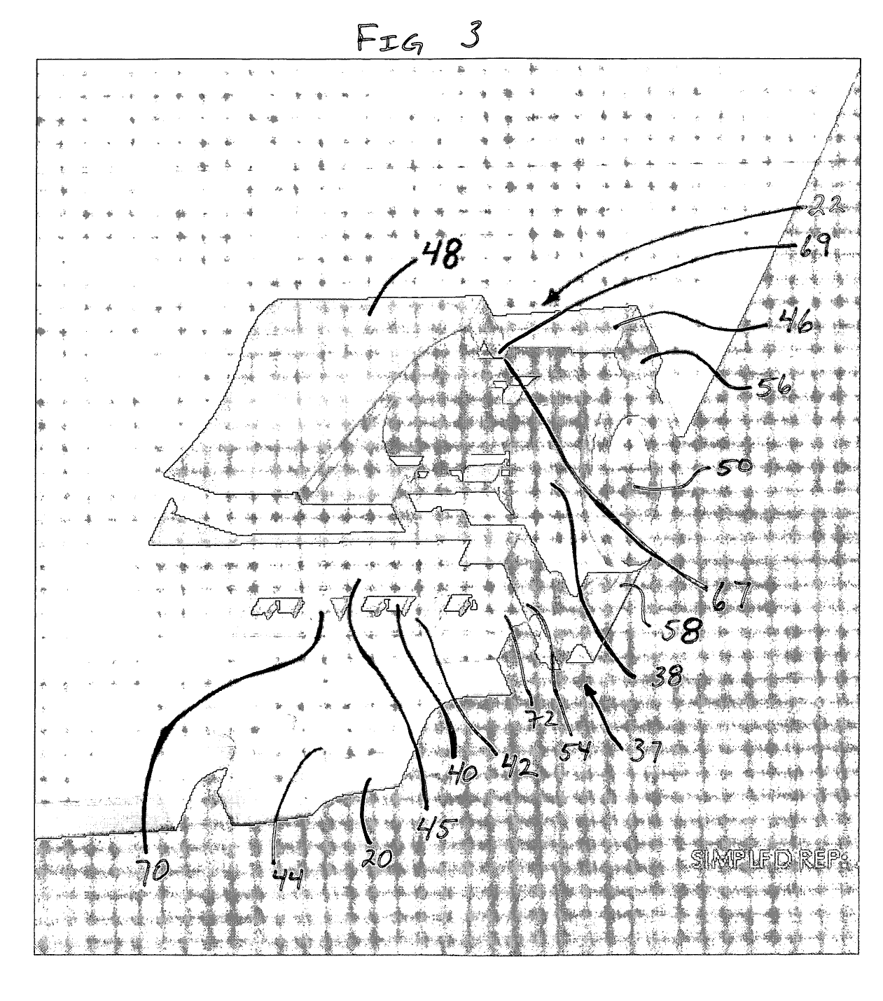

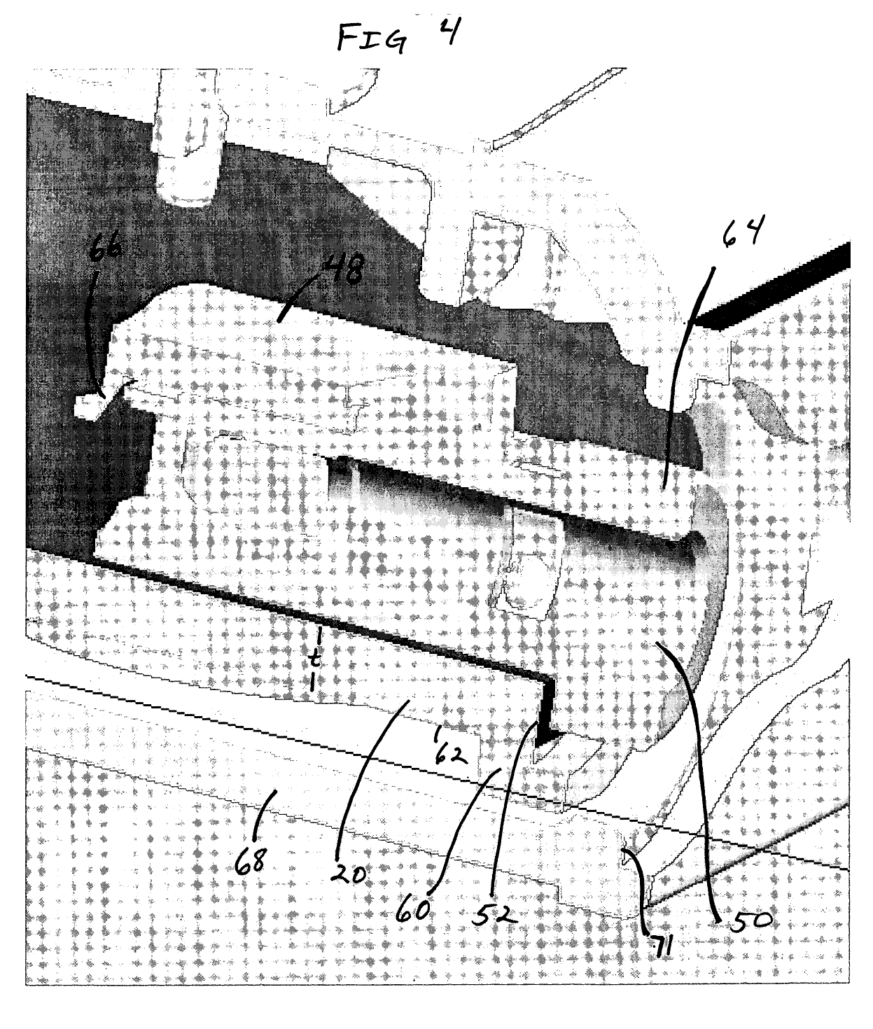

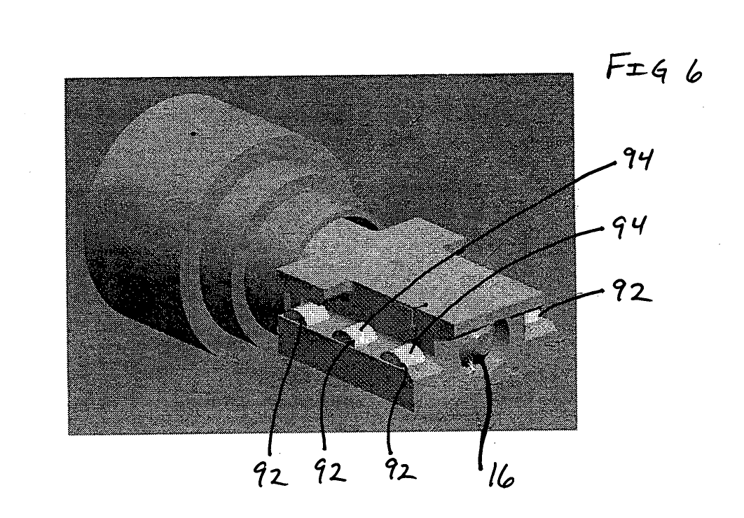

Referring to FIGS. 1 and 2, an audio jack 10 in accordance with the present invention is illustrated. The audio jack 10 has a body 12 in which an elongate bore 14 is formed. The bore serves as a receiver port 14 for an audio plug 16 (FIG. 6), as will be described hereinafter. The jack body 12 has a holding portion 18 that is arranged and configured to maintain the audio jack 10 in secure engagement with a PCB 20 without the need for separate mounting bracket 22 (FIGS. 3 and 4) for this purpose. Accordingly, the integrated holding portion 18 simplifies assembly of the audio jack 10 to the PCB 20, as the audio jack 10 can be mounted to the PCB 20 in a single assembly operation.

As can be seen, the jack body 12 includes a main block body portion 24 in which the bore or plug port 14 is centrally formed with axis 14a extending centrally therethrough. The block body portion 24 has a generally rectangular configuration so that it includes opposite side surfaces 26 and 28, upper and lower surfaces 30 and 32, and end surfaces 34 and 36. The side surfaces 26 and 28 extend axially for a length, L, between the end surfaces 34 and 36, which are spaced laterally by a width, W, and the upper and lower surfaces 30 and 32 are spaced by a height distance, H. By way of example and not limitation, L can be approximately 11 mm, W can be approximately 4.5 mm, and H can be approximately 3.5 mm.

As previously mentioned, it is preferred for the holding portion 18 to be integral with the jack body 12 to provide advantages in assembly over the prior audio jack assembly 37 including the separate mounting bracket 22 and audio jack 38, as shown in FIGS. 3 and 4. Integral should also be understood to include a physically interconnected holding portion 18 and body portion 24 that are rigidly fixed relative to each other so that there are not two separate pieces that need to be manipulated for PCB mounting, although it is preferred to form the jack 10 as a single component. In addition to assembly concerns, the prior audio jack assembly 37 has a relatively high profile over the PCB 20.

The prior audio jack 38 has conductor lead legs 40 that extend out from the bottom thereof for being placed on top of the surface contact pads 42 on the circuit board as shown in FIG. 3. As is known, these contact pads 42 typically are electrically coupled with additional routing, solder and/or other conductors which further electrically couple to other electrical components on the PCB 20, such as amplifiers, detectors and other such circuit components. Accordingly, the entire height of the body of the audio jack 38 extends above PCB surface 44 on which the contact pads 42 are formed.

In addition to the high profile of the audio jack 38 itself, the mounting bracket 22 is configured with side portions 45 and 46 interconnected by an upper, roof or bridge portion 48 that extends over the top of the audio jack 38. The bridge portion 48 stops short of the end of the bracket member 22 through which the audio jack 38 projects with the receiver port 50 extending beyond the PCB edge 52 for receiving an audio plug 16 therein. The bracket 22 has vertical portions 54 and 56 that extend down from the corresponding side portions 45 and 46 adjacent the PCB edge 52 and are interconnected by lower arcuate portion 58 to form the lower extent of the opening in the bracket member 22 through which the audio jack 38 projects. The arcuate portion 58 further includes a lower extension portion 60 which has a spacing from the upper bridge portion 48 that is coordinated with the height of the audio jack 38 and thickness, t, of the PCB between the upper surface 44 and lower surface 62 thereof such that the extension 60 engages the board lower surface 62, as best seen in FIG. 4.

In addition, to keep the audio jack 38 from sliding along the board surface 44 additional complexities are introduced into the configurations of the audio jack 38 as well as the separate or independent mounting bracket 22 therefor. There is an enlarged annular flange 64 formed at the end of the jack 38 for abutting against the PCB edge 52, and the mounting bracket 22 is also provided with a lip portion 66 that depends from the bridge portion 48 adjacent the other end of the audio jack 38 so that sliding thereof toward the interior of the casing 68 of an electronic device is avoided. While the mounting bracket 22 includes leg portions 70 and 71 on either side portion 45 and 46 thereof that extend down into engagement with the board surface 44 and has the extension portion 60 in engagement with the board bottom surface 62, these structures do not provide the bracket member 22 with a secure engagement on the board 20 against sliding in a direction outward from the casing 68. Instead, the casing 68 also has a flange portion 65 that is in interference with the bracket arcuate portion 58 to retain the bracket member 22 against sliding in a direction outward from the electronic device casing 68, as shown in FIG. 4. Further, the audio jack 38 has an external, intermediate groove or recess 67 in which an intermediate, inward projection 69 of the bracket 22 fits to keep the audio jack 38 from sliding relative to the bracket 22.

With the audio jack 10 herein, a separate, complexly configured mounting bracket member 22 is rendered unnecessary due to the provision of the integral holding portion 18, as previously discussed. In addition, the holding portion 18 may be configured for sliding engagement with the PCB 20 by the provision of at least a pair of opposing side extension portions or gripping members 72 and 74 arranged on one end or side of the block body portion 24. As illustrated, preferably two pairs of opposing gripping members 72, 74 and 76, 78 on either side of the block body form 24 are provided. These pairs of gripping members 72-78 are spaced from each other so that the PCB 20 fits tightly therebetween thereby substantially keeping the audio jack 10 from shifting transversely to the plane of the PCB 20. Since the gripping member 72-78 are integrally connected to or formed with the main block body portion 24 of the audio jack body 12, PCB mounting is accomplished with a single, sliding assembly operation so that the audio jack 10 is securely mounted to the PCB 20.

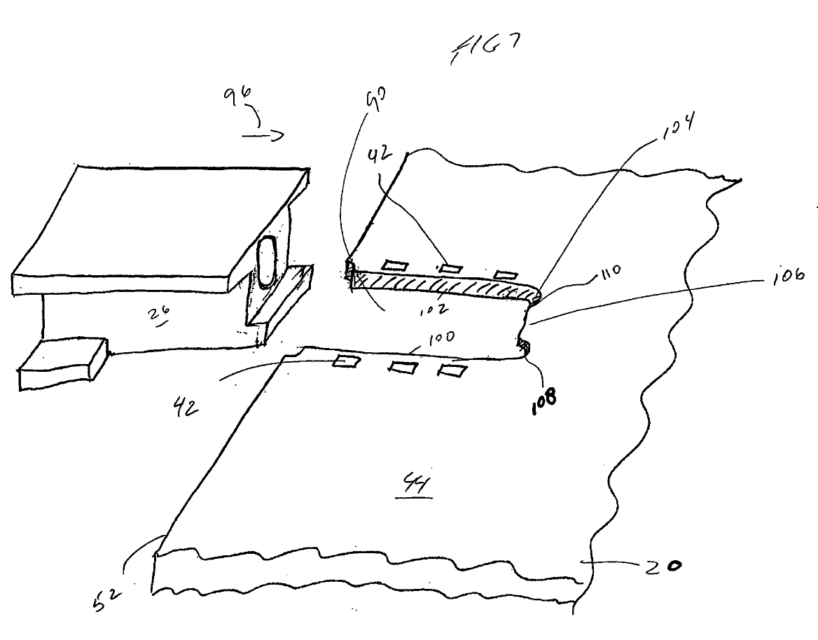

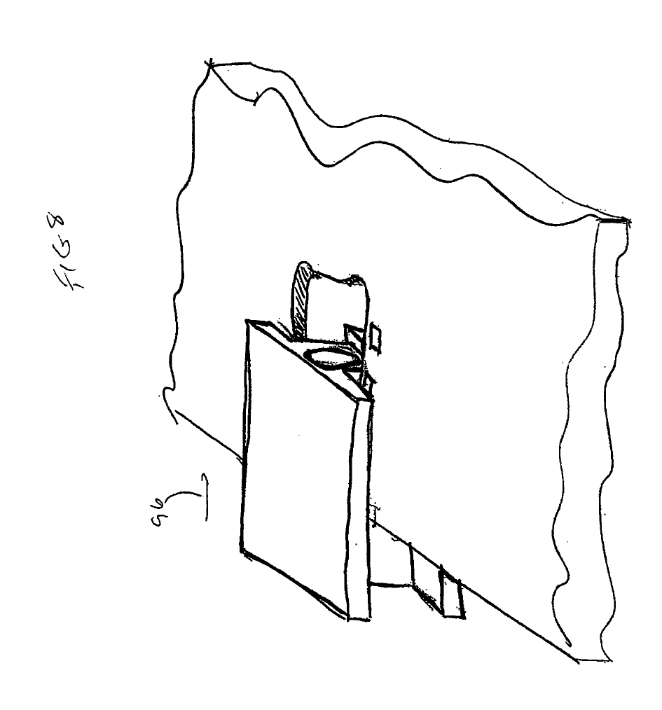

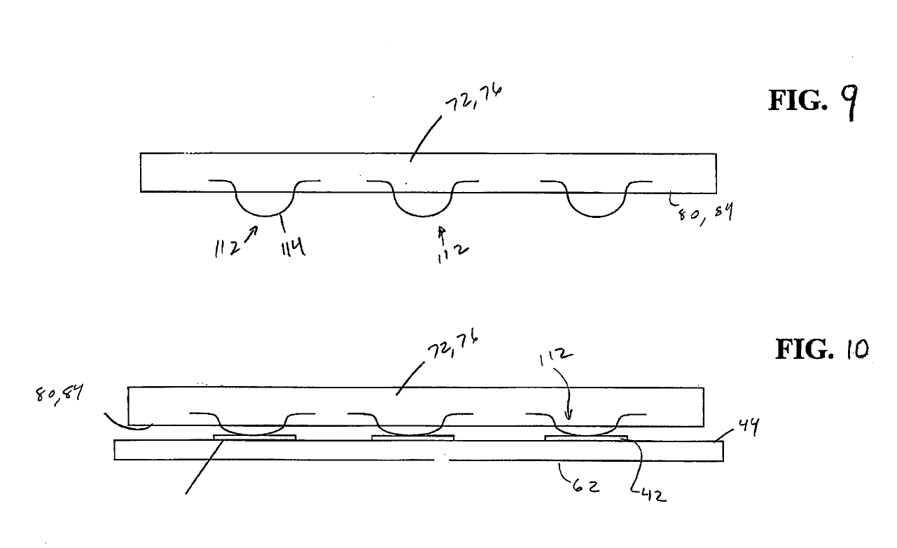

The sliding engagement between the gripping members 72-78 and the PCB 20 provides the audio jack 10 with a relatively simple PCB mounting operation, as depicted in FIGS. 7, 8 and 11. Referring to FIG. 1, it can be seen that gripping members 72 and 76 are preferably upper gripping members 72 and 76 which are formed as elongate rail flanges along the entire length, L, of the block body portion 24 with their upper surface being flush and coextensive with upper surface 30. Similarly, gripping members 74 and 78 are preferably lower gripping members 74 and 78 which are formed as lower wing flanges which have their lower surface flush and coextensive with the block lower surface 32, as can be seen in FIG. 2. The wing gripping members 74 and 78 extend axially from the end surface 36 for less than half the full length, L, of the block body portion 24.

Each of the gripping member pairs 72, 74 and 76, 78 include respective facing surfaces 80, 82 and 84, 86 that have a flat configuration and extend parallel to each other. The distance, D, between the facing surfaces 80 and 82, and 84 and 86 can be substantially matched to the thickness, t, of the PCB 20, as measured between the PCB upper and lower surfaces 44 and 62. In this manner, there is a sliding, tight or snug fit, such as friction or tolerance fit, between the gripping member 72-78 and PCB 20. By way of example, the distance D can be slightly larger than the thickness t by approximately 0.02-0.10 mm to provide a very snug, but slight clearance fit between the audio jack 10 and the PCB 20. Alternatively, the gripping members spacing D can be approximately 0.10-0.25 mm less than the PCB thickness t to provide a slight interference fit with a compression or bias force generated between the audio jack 10 and the PCB 20. This tight or snug fit provides secure mounting of the audio jack 10 to the PCB 20 for maintaining contacts 88 of the jack 10 in secure electrical contact with the corresponding contacts 42 of the PCB 20, especially as the plug 16 is inserted and removed from the port 14. The friction fit is preferred where it is desired to avoid additional contact connecting operations as by soldering or the like.

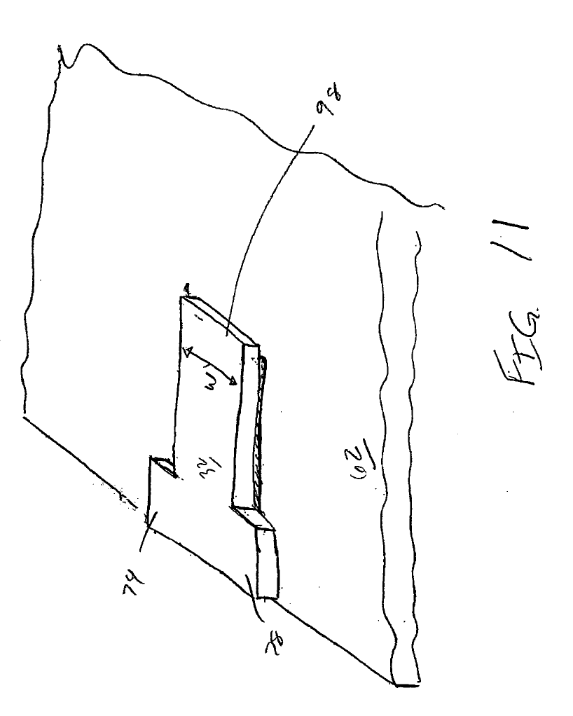

Also, since these are preferably upper and lower gripping members of the audio jack body 12 as described above, it can be seen that with the jack 10 slide fit to the circuit board 20 in FIG. 11, the audio jack 10 will have a very low profile relative thereto. In this regard, the central axis 14a of the plug port 14 will be substantially aligned with the middle of the PCB 20 between the surfaces 44 and 62 thereof so that only the thickness of the flange gripping members 72-78 will extend above and below the corresponding board upper and lower surfaces 44 and 62. As such, the full height, H, of the audio jack 10 entirely overlaps the thickness, t, of the PCB 20 which correspondingly reduces the amount the jack body 12 projects above or below the corresponding PCB surfaces 44 and 62. The low profile of the audio jack 10 allows for a thinner or lower profile casing 68 and/or provides space for other components in the casing 68.

In the preferred and illustrated form, the PCB 20 has a cut-out opening extending into the circuit board 20 from the edge 52 thereof with the audio jack body 12 being sized to fit therein, as can be seen in FIGS. 7, 8 and 11. In this regard, the axis 14a of the plug port 14 is preferably laterally aligned with the gaps formed between the gripping member pairs 72, 74 and 76, 78. In this manner, with the jack body 12 fully slid into the cut-out opening 90 as shown in FIG. 11, the plug port 14 will be laterally aligned with and disposed in the cut-out opening 90. Accordingly, space in the device casing 68 for the present audio jack 10 and the PCB 20 is conserved both in terms of profile or height as well as in terms of the amount of space required for the audio jack 10 beyond the circuit board edge 52. Further, by having the gripping members 72-78 be formed as side extension flange portions of the jack body 12, the width, W, of the block body 24 can be kept to minimum so that the slot width is likewise minimized to reduce the amount of PCB surface area taken up by the provision of the cut-out slot opening 90.

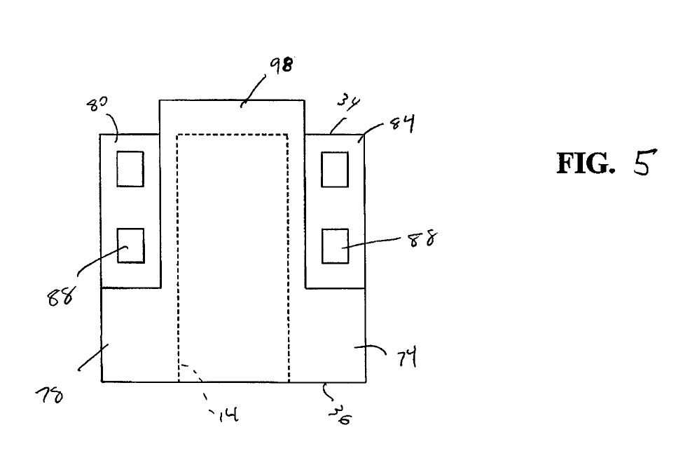

As shown in FIGS. 2 and 5, the audio jack contacts 88 can be substantially flat, pad-type contacts similar to the contact pads 42 on the circuit board 20. The contacts 88 are arranged along each of the rail members 72 and 76 such as with three contacts 88 spaced equally along the length thereof and with a similar spacing to that of the PCB contacts 42. It can be seen that the PCB contacts 42 extend along either side of the cut-out opening 90. Thus, when the audio jack 10 is slid into the opening 90, the contacts 88 will be brought into engagement with the PCB contacts 42 and securely, frictionally held thereon due to the previously described friction fit between the gripping members 72-78 and PCB surfaces 44 and 62. Thus, the contacts 88 of the upper, rail gripping members 72 and 76 act as portions of the gripping members 72 and 76 for securely holding the audio jack 10 on the PCB 20. Accordingly, in this instance, the distance, D, is taken from the surface of the contacts 88 to the facing surface 82 and 86 on the wing gripping members 74 and 78, respectively with this distance, D, being substantially the same or slightly less than the thickness, t, between the surface of the PCB contacts 42 and the PCB bottom surface 62.

If there is slight interference in this tight, sliding fit between the audio jack 10 and the PCB 20, it will be understood that either the gripping members 72-78 or the PCB 20 or both will undergo some slight flexing or deformation for the above-described fit to be achieved. In this regard, the PCB 20 and the audio jack body 12 are preferably formed of generally insulative materials, such as plastic, silicon or ceramic, that are normally generally rigid. However, in the relatively large flat panel configuration of the PCB 20, and the flanged construction of the gripping members 72-78, their interengaging surfaces will be able to have some give or play to accommodate any slight interference in the fit therebetween.

Instead of flat, low profile contacts 88 as shown in FIGS. 2 and 5, profiled contacts 92 can be formed on the rail gripping members 72 and 76, as shown in FIG. 6. In this instance, the contacts 92 may be formed of a resilient, conductive material so that profiled contacts 92 can slightly compress during the slide mounting of the audio jack 10 to the PCB 20. The profiled contacts 92 preferably include an arcuate, cam engagement surface 94 that is curved in a fore and aft direction along the length, L of the body 12. In other words, the curvature of the engagement surfaces 94 is such that the surfaces 94 curve up from closer to leading end 34 of the jack body 12 in the slide direction 96 to a peak where they then curve back down toward the trailing end 36 of the jack body 12. In this instance, the distance D, is measured from the peaks of the engagement surfaces 94 to the facing wing gripping member surfaces 82 and 86.

With the arcuate surfaces 94 configured as described above, moving the audio jack 10 in the sliding direction 96 relative to the PCB 20 brings the engagement surface 94 of the leading pair of laterally aligned contacts 92 into engagement with the board surface 44. Continued sliding action then bring the second pair of laterally aligned contacts 92 into engagement with the board. Because the leading pair of contacts 92 and immediately following pair of contacts 92 are exposed relative to the underlying wing gripping members 74 and 78, as can be seen best in FIG. 5 with respect to contacts 88, the preferred friction fit between the jack 10 and the circuit board 20 has not yet been initiated. Continued sliding in direction 96 brings the trailing most pair of contacts 92, and specifically the engagement surfaces 94 thereof into engagement with the board surface 44. At this time, any gap that may be present between the circuit board surface 62 and the facing surfaces 80 and 82 is taken up as the contact surfaces 94 cam against the board surface 44. This camming action generates a compressive force between the PCB 20 and the engagement surfaces 94 progressively increasing the engagement force between the PCB surface 44 and cut-out engagement surfaces 94 and similarly increasing the engagement force between the wing gripping member surfaces 82 and 86 and the PCB surface 62. This compressive force can cause the board surfaces 44 and 62 to be squeezed and moved closer together, the gripping members 72, 74 and 76, 78 including the associated contacts 92 to move further apart, or a combination of both actions so that a friction fit between the audio jack gripping members 72-78 including the profiled contacts 92 and the board surfaces 44 and 62 is established.

As previously mentioned, it is preferred for the wing gripping members 74 and 78 to extend for only a short amount of the length L of the jack body 12 to keep their size to a minimum for ease in assembly and establishing the preferred tight fit between the audio jack 10 and PCB 20. To enhance the stability of the gripping action on the board bottom surface 62, a leading extension portion or gripping member 98 is formed to project out from the leading surface 34 of the block body portion 24 at the lower end thereof. As can be seen in FIG. 2, the extension gripping member 98, like the wing gripping members 74 and 78, is formed so that its lower surface is coextensive and flush with the lower surface 32 of the block body portion 24 of the PCB surface 62.

Referring to FIG. 11, as the jack body 12 is moved in slide direction 96 to be fully inserted in the slot opening 90, the extension gripping member 98 will also be tightly engaged against the PCB surface 62 due to the previously described friction fit. In this manner, the audio jack 10 is provided three points or areas of contact, that are all distinct from each other. More specifically, it can be seen that the wing gripping members 74 and 78 and leading extension gripping member 98 cooperate to form a T-shape for the lower surface 32 of the audio jack body 12. The three areas of contact with the PCB surface 62 as provided by the gripping members 74, 78 and 98 together define a triangular spacing from each other at either side of the trailing end 36 and centrally at the leading end 34 of the audio jack body 12. This triangular arrangement of the contact areas provided by the gripping members 74, 78 and 98 provides the jack 10 with secure and stable engagement with the PCB surface 62.

Turning to more of the details, as previously mentioned the jack body 12 is preferably sized to fit in cut-out opening 90 in the PCB 20. To this end, the width distance, W, between side surfaces 26 and 28 of the block body portion 24 is sized to be in clearance with the side edges 100 and 102 of the cut-out slot opening 90. In other words, the distance between the cut-out opening edges 100 and 102 is greater than the width, W, between the surfaces 26 and 28. To properly locate the jack body 12 in the cut-out opening once fully inserted therein, the back edge 104 of the opening 90 interconnecting the side edges 100 and 102 is provided with a centering projection 106. Referring to FIG. 5, it can be seen that the bore 14 can extend for the entire length, L, of the jack body 12 between end surfaces 34 and 36 thereof.

The projection 106 is centered between the side edges 100 and 102 and has tapered sides 108 and 110 that extend toward each other as they project toward board edge 52. Thus, as the projection 106 is received in the leading end of the plug port 14 continued sliding of the jack 10 in direction 96 will cause annular surface 103 of the plug port 14 to tightly engage against the tapered sides 108 and 110 to substantially, rigidly center the jack body 12 in the opening 90. In this manner, the centering projection 106 received in the bore 14 in conjunction with the friction fit described above operates to minimize unwanted shifting of the audio jack 10 relative to the PCB 20. The centering projection 106 also serves as an abutment for the plug 16 received in the through bore 14 so that the distal end of the plug 16 bottoms out against the projection 106 to limit its depth of insertion in the bore 14.

Another possible configuration for the audio jack contacts is depicted in FIGS. 9 and 10. In this form, the contacts 112 are formed of a sheet of conductive material and are shaped or bowed to provide a profiled, arcuate cam surface 114 akin to the cam surface 94 of the contacts 92. As can be seen in FIG. 10, these sheet metal contacts 112 have resiliency or flexibility to provide a bias force when engaged with the PCB contacts 42 to maintain good electrical contacting engagement therebetween. In this regard, when engaged with PCB contacts 42, the contacts 112 can flex so that their peaks shift closer to rail gripping member surfaces 80, 84 to essentially spring load those contacts 112 against the PCB contacts 42.

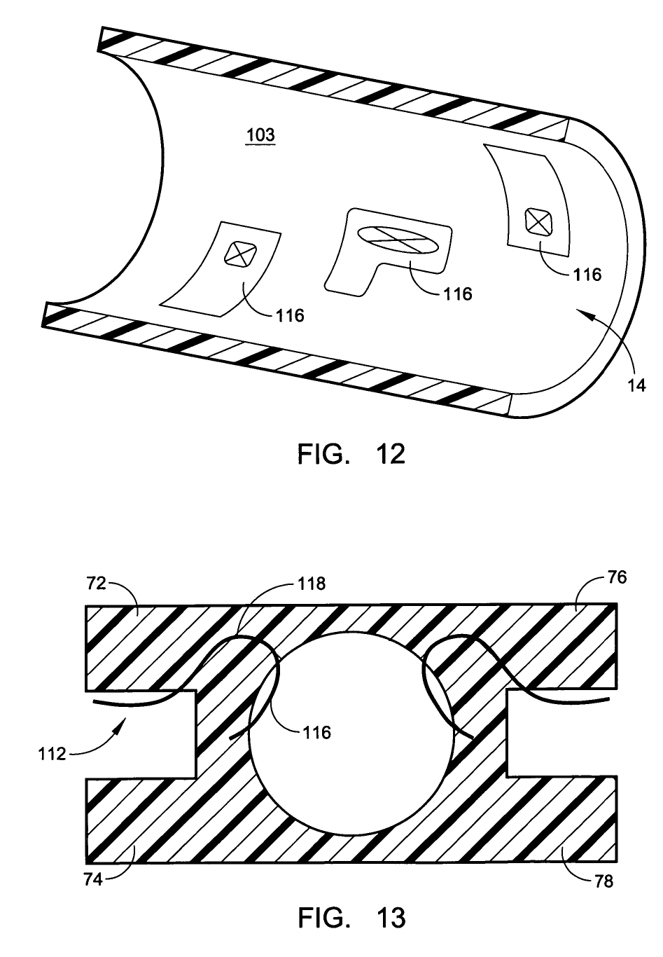

Referring to FIGS. 12 and 13, the contacts 112 are electrically connected to internal contacts 116 exposed on the internal bore surface 103 via an electrical lead portion 118. A similar arrangement for electrically interconnecting external jack contacts 88 or 92 with internal jack contacts 116 is also provided. With respect to the sheet metal contacts 112, the lead portions 118 can be integral therewith and extend through the audio jack body 12 to an exposed contact portion 116 in the plug port 14. With the plug 16 inserted in the port 14, it will be electrically connected to the internal contacts 116 and thereby in electrical communication with circuitry of the PCB 20 via the lead portions 118, audio jack external contacts 112 and the PCB contacts 42.

It should be understood that the gripping member 72-78 can be utilized to securely position the contacts 88, 92 or 112 against the PCB contacts 42 for soldering the contacts together. In this instance, a friction fit can be utilized although a slight clearance fit as previously described could also advantageously be employed. Usually the PCB 20 is mounted in the device casing 68 via mounting posts or bosses and/or by use of fasteners such as screws, or rivets and the like. Once the device is assembled, portions of the casing or other components held in the casing can also serve to securely maintain the audio jack 10 against shifting relative to the PCB 20. For instance, the casing flange 65 can be positioned against the jack end 36 so that the casing flange 65 and inner or back edge 104 of the PCB cut-out opening 90, and specifically the projection 106 thereof, cooperate to secure hold the jack 10 in the PCB opening 90.

While the invention herein disclosed has been described by means of specific embodiments and applications thereof, numerous modifications and variations could be made thereto by those skilled in the art without departing from the scope of the invention set forth in the claims.

1. An audio jack for being electrically connected to a printed circuit board, the audio jack comprising:
a jack body;
a plug port of the jack body configured for receiving an audio plug therein;
a plurality of electrical contacts of the body for cooperating with corresponding contacts of the printed circuit board; and
a holding portion of the jack body that is integral therewith and configured to engage the printed circuit board for maintaining the jack body electrical contacts in secure electrical contact with the circuit board contacts as the plug is received in the port, wherein the holding portion includes opposing side extension portions along at least one side of the plug port and having a space therebetween sized for receiving the printed circuit board therein and an end projection that is substantially perpendicular to the opposing side extension portions and that extends beyond an end of the jack body.

2. The audio jack of claim 1 wherein the plug port has a central axis generally laterally aligned with the space to permit the jack body to fit in a cut-out of the circuit board and have a low profile configuration relative thereto.

3. The audio jack of claim 1 wherein the holding portion includes gripping members for tightly engaging against opposite surfaces of the printed circuit board.

4. The audio jack of claim 3 wherein the gripping members include at least one of the jack body electrical contacts.

5. The audio jack of claim 1 wherein the jack body electrical contacts are associated with the holding portion.

6. The audio jack of claim 1 wherein the jack body electrical contacts have a cam surface for sliding engagement with the circuit board and the contacts thereof.

7. The audio jack of claim 1 wherein the holding portion comprises a first member carrying the jack body contacts and a second member spaced from the first member contacts by a predetermined distance sized so that the circuit board fits tightly between the contacts and the second member.

8. The audio jack of claim 7 wherein the first and second members extend beyond either side of the plug port and the first member extends along the plug port to carry more than one of the plurality of jack body contacts on either side of the plug port.

9. The audio jack of claim 8 wherein the first member extends for a greater distance along the plug port than the second member for keeping the size of the second member to a minimum.

10. A jack for being electrically connected to a printed circuit board and for receiving a plug electrically connected thereto, the jack comprising:
a jack body having a central bore configured for receiving a plug therein; and
upper and lower gripping members connected to the jack body on either side of the central bore with the upper and lower gripping members spaced from each by a predetermined distance sized to substantially match a thickness of the printed circuit board for being slidingly engaged on opposite surfaces thereof, wherein one of the upper and lower gripping members include opposite side extensions and an end projection that is substantially perpendicular to the opposite side extensions and extends beyond an end of the jack body for providing three distinct areas of engagement with a corresponding surface of the printed circuit board.

11. The jack of claim 10 wherein the gripping members are generally above and below the jack body bore.

12. The jack of claim 10 wherein one of the upper and lower gripping members include electrical contacts for engaging on corresponding contacts of the printed circuit board.

13. The jack of claim 12 wherein the electrical contacts have an arcuate engagement surface for sliding engagement with the printed circuit board contacts.

14. The jack of claim 12 wherein the jack bore has exposed electrical contacts therein electrically connected to the electrical contacts of the one of the upper and lower gripping members.

15. (canceled)

16. The jack of claim 10 comprising an audio jack.

17. A device including an audio jack system for communicating audio signals to and from the device, the audio system comprising:
a printed circuit board having an edge and a cut-out opening at the edge;
an audio jack having a body that is sized to fit in the cut-out opening of the circuit board so that the audio jack body has a low profile relative to the printed circuit board;
wherein the printed circuit board has opposite surfaces and a predetermined thickness between the surfaces thereof, the audio jack body has a plug port configured for receiving an audio plug therein and gripping portions spaced relative to the predetermined thickness of the printed circuit board to slidingly engage the opposite surfaces thereof and arranged relative to the plug port such that at least a portion of the plug port is positioned within the cut-out;
wherein the audio jack body also includes an end projection that is perpendicular to the gripping portions, extends beyond the audio jack body and engages the printed circuit board when the audio jack body is fitted within the cut-out opening of the printed circuit board.

18. (canceled)

19. The device of claim 17 wherein the printed circuit board has electrical contacts on one of the surfaces thereof, and the gripping portions include electrical contacts configured for sliding along the one surface of the printed circuit board into engagement with the printed circuit board contacts.

20. The device of claim 17, including a casing having an interior space in which the printed circuit board and the audio jack are disposed with the casing including an abutment portion for maintaining the audio jack body within the cut-out.
